(19) United States
(12) Patent Application Publication
(10) Pub. No.: US 2003/0111888 A1
(43) Pub. Date: Jun. 19, 2003

(54) Vehicle passenger seat

(76) Inventor: Edward J. Brennan, Litchfield, CT (US)

Correspondence Address: Adams, Schwartz & Evans, P.A., 2180 Two Wachovia Center, Charlotte, NC, 28282, US

(21) Appl. No.: 10/323,294

(22) Filed: Dec. 18, 2002

Related U.S. Application Data
(60) Provisional application No. 60/341,760, filed on Dec. 18, 2001.

(51) Int. Cl. B60N 2/00; B60N 2/02

(52) U.S. Cl. 297/316

(57) ABSTRACT

A passenger seat including a seat base for being mounted on a support surface. A seat frame is carried by the seat base, and includes a seat bottom frame member and a seat back frame member is positioned in a fixed angular relation to each other and the seat base. A seat bottom pan is positioned on the seat bottom frame member. A seat back pan is positioned on the seat back frame member. Guide means cooperate with the bottom pan and bottom frame members and the back pan and back frame members, respectively, for unison translational movement of the back pan and the bottom pan between an upright position when the bottom pan is in the aft position and a recline position when the bottom pan is in the forward position.

### TECHNICAL FIELD AND BACKGROUND OF THE INVENTION

This invention relates to a vehicle passenger seat intended for passenger conveyances including, but not limited to, buses, airplanes and trains. Although the passenger seat may be utilized in any type of vehicle, the passenger seat is preferably intended to be utilized for carrying economy class passengers in an aircraft. Unlike conventional passenger seats, the passenger seat of the present invention is capable of being quickly moved between upright and reclined positions without interfering with aft-seated passengers or compromising the safety and comfort of the seat.

A conventional passenger seat typically includes a cushioned seat back and seat pan connected to a seat frame. The seat frame is affixed to the deck of an aircraft or other vehicle using conventional means. The seat pan is connected to the seat frame in a manner that maintains the seat pan in a stationary position, and the seat back is pivotally attached to the seat frame in a manner that permits the seat back to move rearward between upright and reclined positions without changing the position of the seat pan. In particular, the seat back is attached to the seat frame using a pivot mechanism located near the intersection of the seat back with the seat pan.

Although the seat backs of prior art seats typically move between 3 and 5 inches to arrive at a reclined position, such movement is not achieved without compromise. Because the seat pan does not move in concert with the seat back, a seated passenger will inevitably experience lower back discomfort due to pelvic rotation and slouching after the seat back has been moved. Such prior art seats offer no means for preventing such discomfort, and actually cause the slouching passenger to potentially irritate other passengers by occupying additional space. The aft movement of the seat back is often perceived by an aft-seated passenger as an invasion of that passenger's perceived space. Furthermore, sudden aft movement of the seat back can result in impact to the aft-seated passenger's knees, or to a computer sitting on an open tray table or on the passenger's knees.

While certain prior art passenger seats exist that include a mechanism for supporting the cushioned seat pan that also causes the pan to move in concert with the seat back, such mechanisms possess specific flaws. Even though the mechanism causes the cushioned seat pan to move in a way that alleviates pelvic rotation and lower back discomfort to a passenger sitting in the seat, the concerted movement of the seat pan with the seat back causes the forward edge of the seat pan—the area of the seat located behind the knees of a seated passenger—to lift slightly. Unless a foot rest has been installed on the seat, this upward motion will cause discomfort to the passenger's legs. Because such seats have seat backs that move aft and seat pans that move forward and upward, the seats not only compromise circulation in the passenger's legs, but also actually occupy even more space than those seats whose cushioned seat pans do not move.

Conventional passenger seats also typically include armrests possessing several disadvantages. For example, such armrests are pivotally connected to the seat frame and extend through respective spaces defined between adjacently-positioned seats. Connecting the armrests to the seat frame by a pivot mechanism permits the central armrests to fold upwardly into the respective spaces. While moving the armrests into the space between adjacent seats does provide a convenient stowage solution, the solution is far from ideal.

Positioning the armrest in the respective stowage spaces restricts the width of each seat back and tray table attached thereto to the width between armrests. Furthermore, each pivot used to connect an armrest to a seat frame is also exposed and must be robust in order to withstand wear and passenger abuse.

The invention of the present application overcomes the disadvantages of prior art passenger seating by providing a vehicle passenger seat that includes a seat back pan and seat bottom pan that are connected and move relative to a stationary seat frame. The seat also includes an articulating bolster that moves in concert with the seat bottom pan and seat back pan between upright and reclined positions without jeopardizing the safety and comfort of aft-seated passengers. Use of the bolster causes the leading edge of the seat bottom pan to move forward and then downward to accommodate and support the seated passenger's legs. Unlike prior art seats which compromise circulation in a seated passenger's legs by driving the forward edge of the seat pan upwardly and into the back of the passenger's knees when the seat is reclined, the bolster and seat bottom pan of the present invention enhance the comfort and safety of the seat. The passenger seat of the present application also includes armrests that pivot forward to rest below and forward of the seat bottom pan rather than in between the seat backs.

### SUMMARY OF THE INVENTION

Therefore, it is an object of the invention to provide a vehicle passenger seat that maximizes the physical comfort and safety of a passenger sitting in the seat.

It is another object of the invention to provide a vehicle passenger seat that can be moved between an upright position and a reclined position.

It is another object of the invention to provide a vehicle passenger seat that can be moved to and from a reclined position without encroaching upon the space occupied by an aft-seated passenger.

It is another object of the invention to provide a vehicle passenger seat that includes armrests having an ergonomically improved manner of being stowed, and which eliminate the mass of the sections required for conventional, fold-up armrests.

It is another object of the invention to provide a vehicle passenger seat that has a seat bottom providing additional padding behind a seated passenger's legs when the seat is reclined, thereby increasing the safety and comfort of the passenger.

It is another object of the invention to provide a vehicle passenger seat that is comfortable.

It is another object of the invention to provide a vehicle passenger seat that is durable.

It is another object of the invention to provide a vehicle passenger seat which is lightweight and extensible.

These and other objects of the invention are achieved in the preferred embodiments described below by providing a passenger seat including a seat base for being mounted on a support surface. A seat frame is carried by the seat base, and includes a seat bottom frame member and a seat back frame member positioned in a fixed angular relation to each other and the seat base. A seat bottom pan is positioned on the seat bottom frame member and a seat back pan is positioned on the seat back frame member. Guide means cooperate with the seat bottom pan and the seat bottom frame member and the seat back pan and seat back frame member, respectively, for unison translational movement of the seat back pan with the seat bottom pan between an upright position when the seat bottom pan is in an aft position and a recline position when the seat bottom pan is in a forward position. The angular relation between the seat back pan and the seat bottom pan movement causes axial rotation of a passenger seated in the seat between an upright and recline position within the seat frame and without aft movement of the seat back frame during recline movement.

According to one preferred embodiment of the invention, the guide means includes a plurality of spaced-apart rollers carried collectively by the seat bottom pan and the seat back pan and projecting outwardly from opposing lateral sides thereof. Respective guide slots are formed in the seat bottom frame member and the seat back frame member within which the rollers are positioned for movement therein.

According to another preferred embodiment of the invention, the guide means include a plurality of spaced-apart rollers carried collectively by the seat bottom pan and the seat back pan and projecting outwardly from opposing lateral sides thereof. Respective guide slots are formed in the seat bottom frame member and the seat back frame member within which the rollers are captured for movement therein.

According to yet another preferred embodiment of the invention, the guide means include a plurality of spaced-apart rollers and complementary guide slots carried by the seat bottom pan, seat back pan, and seat bottom frame member and seat back frame members, respectively.

According to yet another preferred embodiment of the invention, a tray table is pivotally attached to an aft-facing side of the seat back frame member for movement between a storage position against the seat back frame member and a lowered use position. The fixed position of the seat back frame member permits use of the tray table in the lowered use position without regard to whether the passenger in the seat is in the upright or recline position.

According to yet another preferred embodiment of the invention, at least one armrest is pivotally mounted to a side of the seat bottom frame member and is moveable between a raised use position wherein an arm support service of the armrest resides above the seat bottom pan for supporting the forearm of a passenger, and a lowered storage position.

According to yet another preferred embodiment of the invention, a pair of armrest assemblies are pivotally-mounted to opposing sides of the seat bottom frame member and are moveable between a raised use position wherein an arm support surface of the armrest resides above the seat bottom pan for supporting the forearm of a passenger and a lowered storage position.

According to yet another preferred embodiment of the invention, locking means are included for locking the armrest in the raised use position and for unlocking the armrest for movement into the lowered storage position.

According to yet another preferred embodiment of the invention, the locking means is a detent assembly including at least one complementary pair of semicircular male and female detent members movable between a locked position with the male detent member received in the female member and an unlocked position with the male detent member removed from the female member.

According to yet another preferred embodiment of the invention, when in the lowered storage position, the armrest is perpendicular to the raised use position.

According to yet another preferred embodiment of the invention, when in the lowered storage position, the arm support surface of the armrest resides forward of and at the level of the seat bottom pan.

According to yet another preferred embodiment of the invention, a leading edge bolster is positioned on a leading edge of the seat bottom pan and is movable between a raised position when the seat is in the upright position and a lowered position when the seat is in the recline position for relieving pressure on the lower thigh of the passenger.

According to yet another preferred embodiment of the invention, the bolster is positioned for sliding movement on a laterally-extending bar mounted below the seat bottom pan.

According to yet another preferred embodiment of the invention, the bolster is biased towards the lowered storage position.

According to yet another preferred embodiment of the invention, a passenger seat is provided that includes a seat base for being mounted on a support surface. A seat frame is carried by the seat base. The seat base includes a seat bottom frame member and a seat back frame member positioned in a fixed angular relation to each other and the seat base. A seat bottom pan is positioned on the seat bottom frame member, and a seat back pan positioned on the seat back frame member. Guide means cooperate with the seat bottom pan and the seat bottom frame member and the seat back pan and seat back frame member, respectively, for translational movement of the seat bottom pan and the seat back pan between an aft position and a forward position.

According to yet another preferred embodiment of the invention, the passenger seat includes a leading edge bolster positioned on a leading edge of the seat bottom pan and movable between a raised position when the seat is in the upright position and a lowered position when the seat is in the recline position for relieving pressure on the lower thigh of the passenger.

According to yet another preferred embodiment of the invention, the passenger seat includes guide means cooperating with the seat bottom pan and the seat bottom frame member and the seat back pan and seat back frame member, respectively, for translational movement of the seat bottom pan between an aft position and a forward position, and for unison translational movement of the seat back pan with the seat bottom pan between an upright position when the seat bottom pan is in an aft position and a lowered position when the seat bottom pan is in the forward position. The fixed angular relation between the seat back pan and the seat bottom pan during the translation unison movement causes axial rotation of a passenger seated in the seat between an upright and reclined position within the seat frame and without aft movement of the seat back frame during recline movement.

According to yet another preferred embodiment of the invention, the passenger seat includes a tray table pivotally-attached to an aft-facing side of the seat back frame member for movement between a storage position against the seat back frame member and a lowered use position. The fixed position of the seat back frame member permits use of the tray table in the lowered use position without regard to whether the passenger in the seat is in the upright or reclined position.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of a passenger seat according to one preferred embodiment of the invention and placed in an upright position;

FIG. 2 is a perspective view of passenger seat according to FIG. 2 and placed in a fully reclined position;

FIG. 3 is a cross-sectional view taken along Lines 3—3 of FIG. 1;

FIG. 4 is a partial perspective view showing the bottom seat pan and seat back of the passenger seat;

FIG. 5 is a fragmentary cross-sectional view taken along Lines 5—5 of FIG. 4;

FIG. 6 is a partial perspective view of the seat pan and seat back according to FIG. 4 with the armrests disengaged from the seat frame;

FIG. 7 is a fragmentary cross-sectional view taken along Lines 7—7 of FIG. 6;

FIG. 8 is a partial perspective view of the seat pan and seat back according to FIG. 4 showing the armrests being moved to a lowered storage position;

FIG. 9 is a partial perspective view of the seat pan and seat back with the armrests in the lowered storage position;

FIG. 10 is a partial perspective view of the passenger seat showing movement of a bolster positioned on a leading edge of the seat pan between a raised and a lowered position;

FIG. 11 is a rear plan view of the passenger seat with the tray table placed in a stowed position; and

FIG. 12 is a rear plan view of the passenger seat according to FIG. 11 with the tray table placed in a lowered use position.

### DESCRIPTION OF THE PREFERRED EMBODIMENT AND BEST MODE

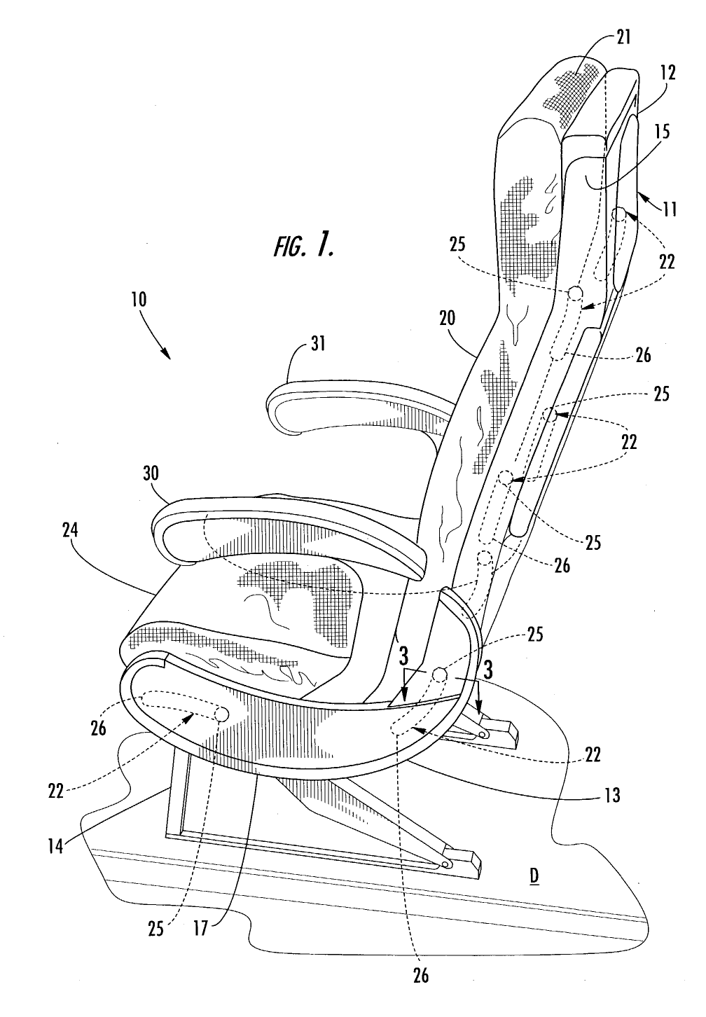

Referring now to FIG. 1, a passenger seat according to one preferred embodiment of the invention is illustrated and shown generally at reference numeral 10. The passenger seat 10 is shown in a fully upright position, and includes a stationary seat frame 11. The seat frame 11 is formed from a seat back frame member 12 and a seat bottom frame member 13. The seat bottom frame member 13 is affixed to a seat base 14, which is in turn mounted on the deck “D” of an aircraft. The seat back frame member 12 and seat bottom frame member 13 are positioned at a fixed angle relative to one another and to the seat base 14, which ensures that the seat frame 11 remains in a stationary position regardless of the extent to which any of other components of the seat 10 may move.

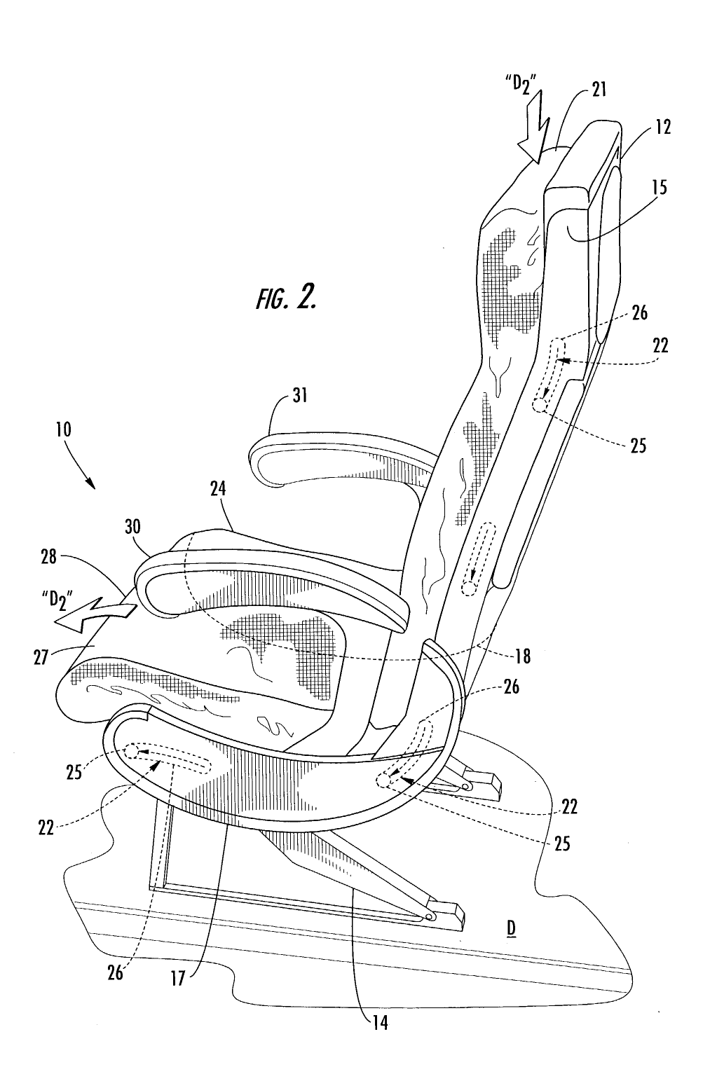

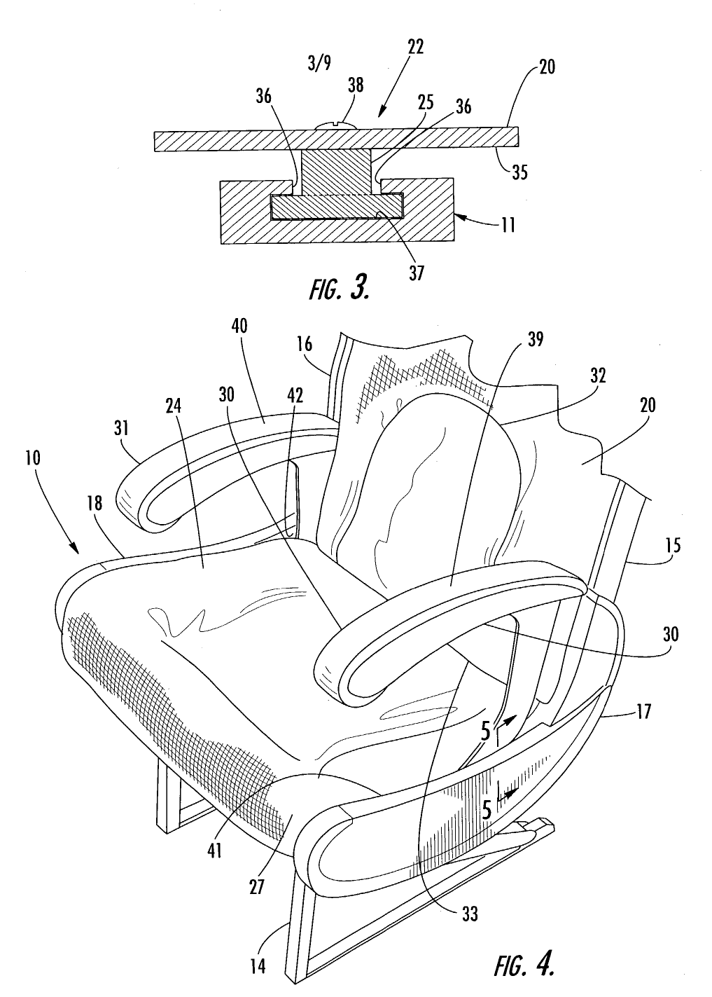

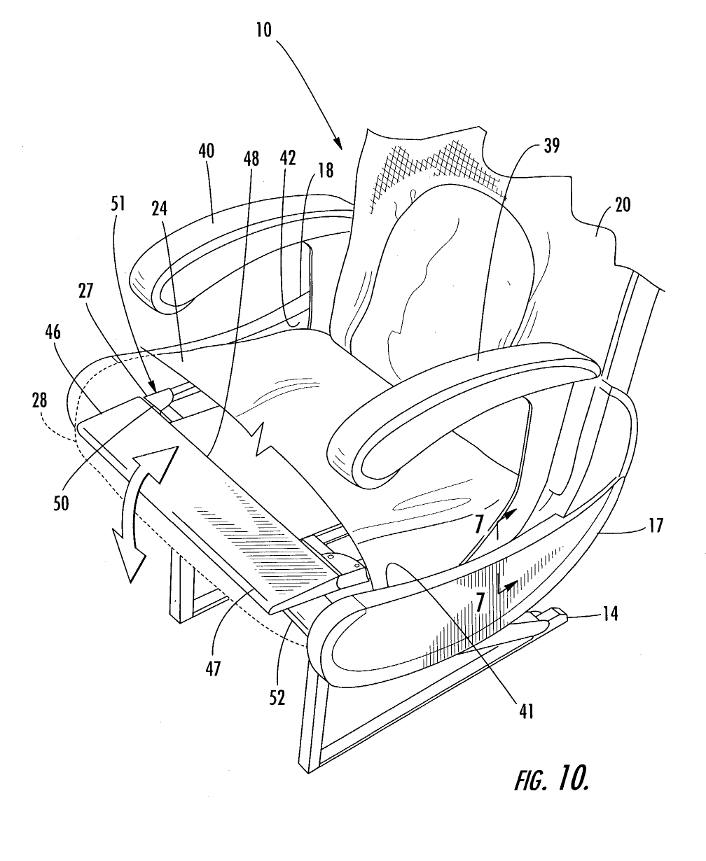

The seat back frame member 12 and seat bottom frame member 13 include pairs of spaced-apart lateral supports 15, 16 and 17, 18, respectively. Supports 16 and 18 are shown in FIG. 4. As is shown in FIG. 1, a cushioned seat back pan 20 with an integrally-formed headrest 21 is mounted between lateral supports 15 and 16 using a plurality of guide mechanisms 22. Additional guide mechanisms 22 are used to mount a cushioned seat bottom pan 24 between lateral supports 17 and 18. The guide mechanisms 22 are mounted in spaced-apart relation along the lateral supports 15, 16 and 17, 18. As is discussed in greater detail below with respect to FIG. 3, each guide mechanism 22 includes a guide pin 25 which is mounted for sliding movement within a guide slot 26. Each guide pin 25 preferably includes a roller; however, the guide pin 25 may alternatively include any device suited for sliding movement within or relative to guide slot 26. Connecting the seat back pan 20, headrest 21 and seat bottom pan 24 to the seat frame 11 using the guide mechanisms 22 permits the seat back pan 20, headrest 21 and seat bottom pan 24 to be moved in concert between the upright position shown in FIG. 1 to a reclined position shown in FIG. 2 without requiring any movement of the seat frame 11. Referring again to FIG. 1, the seat 10 also includes a pair of armrests 30 and 31. As described in greater detail below with reference to FIGS. 4 through 9, the armrests 30 and 31 are mounted on the respective lateral supports 17 and 18 in a manner which permits the armrests 30 and 31 to be moved between the raised use position shown in FIG. 1 and a lowered storage position which is shown in FIG. 9.

Referring again to FIG. 2, the seat 10 is shown being moved from the upright position to a reclined position. Movement of the seat may be powered by any suitable device, including but not limited to pneumatic cylinders, a motor-driven worm drive, or other types of electric or conventional motors. Unlike prior art seat backs, which move aft when articulating from an upright to a reclined position, the passenger seat 10 may be moved to the reclined position shown in FIG. 2 without any aft movement of the seat back frame member 12. Specifically, movement of the guide pins 25 within respective guide slots 26 is initiated, which in turn causes the seat back pan 20 and headrest 21 to move in concert within the stationary, upright seat back frame member 12 in the downward direction “D₁” shown. The seat bottom pan 24 simultaneously moves in the direction “D₂” shown. This permits a passenger sitting in the seat 10 to place the seat 10 in the reclined position without encroaching upon the space occupied by an aft-seated passenger.

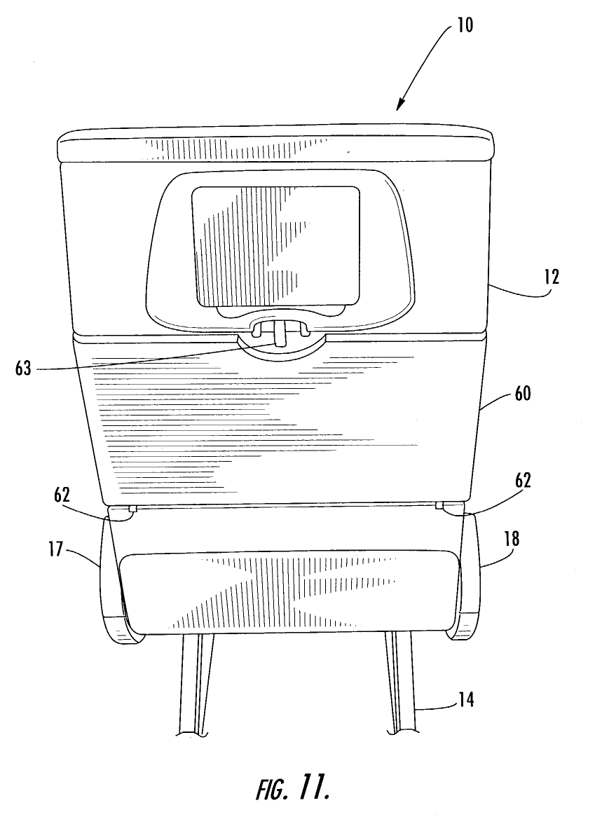

The seat back pan 20 and seat bottom pan 24 cooperate to create a cradle-shaped seating surface for receiving the body of a passenger. The seat 10 provides this seating surface without raising the seated passenger as the seat 10 reclines, and by lowering the passenger's legs to prevent pressure points from developing in the legs over time. This significantly reduces the risk of cramping, discomfort and/or formation of thromboemboli in the passenger's legs, and is achieved by a cushioned bolster 27. The bolster 27 connected for pivotal movement to the seat bottom pan 24. The bolster 27 includes a leading edge 28 and has a cushioned surface that is integrally formed with the cushioned surface of the seat bottom pan 24. As is shown in FIG. 2, the leading edge 28 deflects downwardly in response to the pivotal movement of the bolster 27 and the associated concerted movement of the seat back pan 20 and seat bottom pan 24. The internal structure of the bolster 27 is described further below with reference to FIG. 10

The cushioned surface of the seat back pan 20, headrest 21, seat bottom pan 24 and bolster 27 may be formed from any suitable materials, and may each include a flexible diaphragm to enhance the comfort of a passenger while sitting in the seat 10. A flexible diaphragm may alternatively be used to replace any of the cushioned areas of the seat 10. The seat 10 in FIG. 4 includes a flexible diaphragm 32 positioned adjacent the lower edge 33 of the seat back pan 12. The diaphragm 30 provides enhanced lumbar support to a passenger sitting in the seat 10.

Referring now to FIG. 3, a representative example of one of the guide mechanisms 22 is shown. The guide pin 25 of the selected guide mechanism 22 is connected to and extends outwardly away from an outer lateral surface 35 of the seat back pan 20. As is shown in FIG. 3, the guide slot 26 includes a flange 36 and a chamber 37 into which the guide pin 25 is received. The flange 36 and chamber 37 extend along the length of the guide slot 26 and form a cross-sectional shape complementary to that of the guide pin 25.

Although it may be connected to the seat back pan 20 using any suitable device, the guide pin 25 is preferably held in place on the outer lateral surface 35 by a threaded screw 38. The guide pin 25 is captured within the complementary-shaped guide slot 26 and slides along the longitudinal axis thereof in response to a motor or other conventional drive mechanism. As described above and shown in FIGS. 1 and 2, the directions in which the seat back pan 20 and seat bottom pan 24 simultaneously translate are controlled by the location and shape of the guide slots 26 and the movement of the respective guide pins 25 along the length thereof.

The passenger seat 10 also includes a braking system. The braking system eliminates the need for the hydraulic or gas lock mechanisms that are typically employed in conventional passenger seats. The braking system used in the passenger seat 10 is possible due to the use of the fixed seat back frame member 12 and the equalized side-to-side loading achieved by the seat 10. The braking system of the seat 10 differs significantly from prior art braking mechanisms. In particular, prior art seats typically employ a gas or hydraulic lock located on one side of the seat. Such a lock causes nonsymmetrical loading and requires torque mechanisms within the seat back to allow the seat to maintain a fixed position when loaded on the opposite side of the lock. Because the reliability of prior art recline locks is relatively low, the Federal Aviation Administration requires each lock to have an override feature in case the lock fails when the seat is in the reclined position. This override feature has increased the mechanical complexity and cost of prior art seats.

The braking system used in seat 10 overcomes the problems associated with prior art locks. In particular, because the seat back frame member 12 does not move aft, and because the seat back pan 20 does not have to support a back assist load, the braking system used in seat 10 does not require the override feature used in prior art locks or braking mechanisms. This reduces the complexity and cost of the seat 10.

Referring again to FIG. 4, the passenger seat 10 is shown with the armrests 30 and 31 in a locked use position in which the respective upper surfaces 39 and 40 of the armrests 30 and 31 lie generally parallel to the upper surface of the seat bottom pan 24. The armrests 30 and 31 differ from the armrests of prior art passenger seats. Unlike prior art armrests, which are moved into a stored position by pivoting upwardly to rest between two adjacent seat backs, each armrest 30 and 31 is connected to a respective one of the inner sidewalls 41 and 42 of the lateral supports 17 and 18 in a manner that permits the armrests 30 and 31 to pivot relative to the supports 17 and 18.

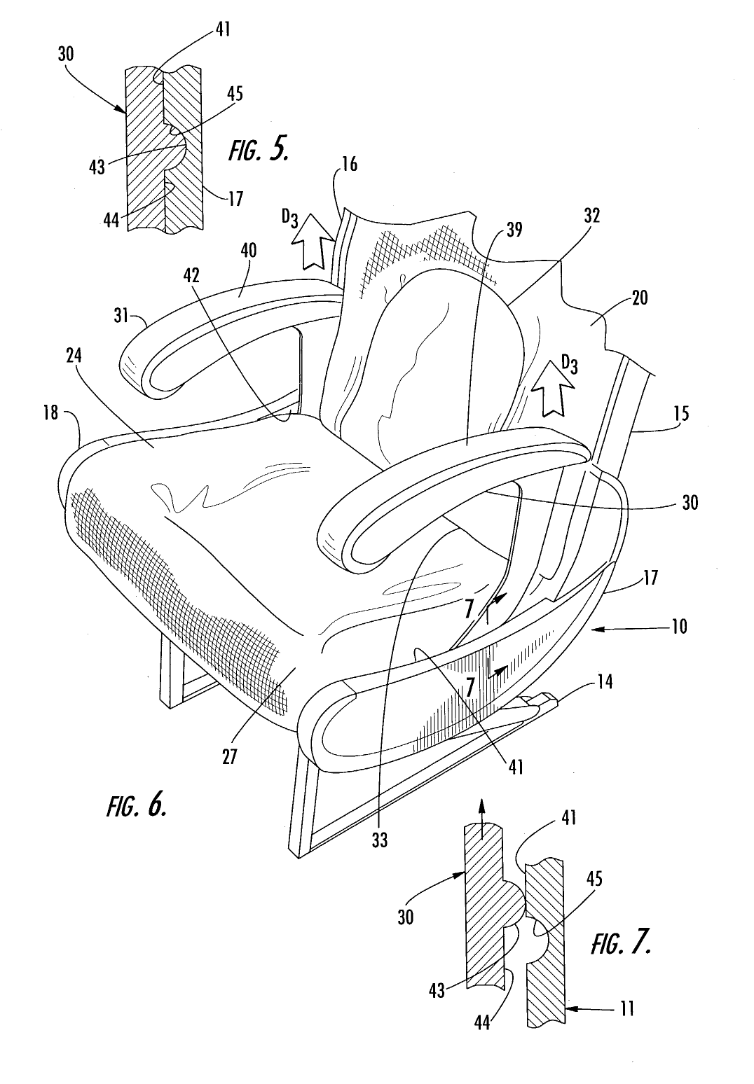

Referring now to FIG. 5 and using armrest 30 as a representative example, the armrest 30 is shown in a locked position against inner sidewall 41. The armrest 30 is maintained in the locked position by a convex male detent surface 43 formed on a lateral wall 44 of the armrest 30. The male detent surface 43 is matingly received within a complementary concave female detent surface 45 formed in the inner sidewall 41, which in turn maintains the armrest 31 in the locked position shown in FIG. 4. Armrest 31 is locked in place against lateral support 18 using an identical detent mechanism.

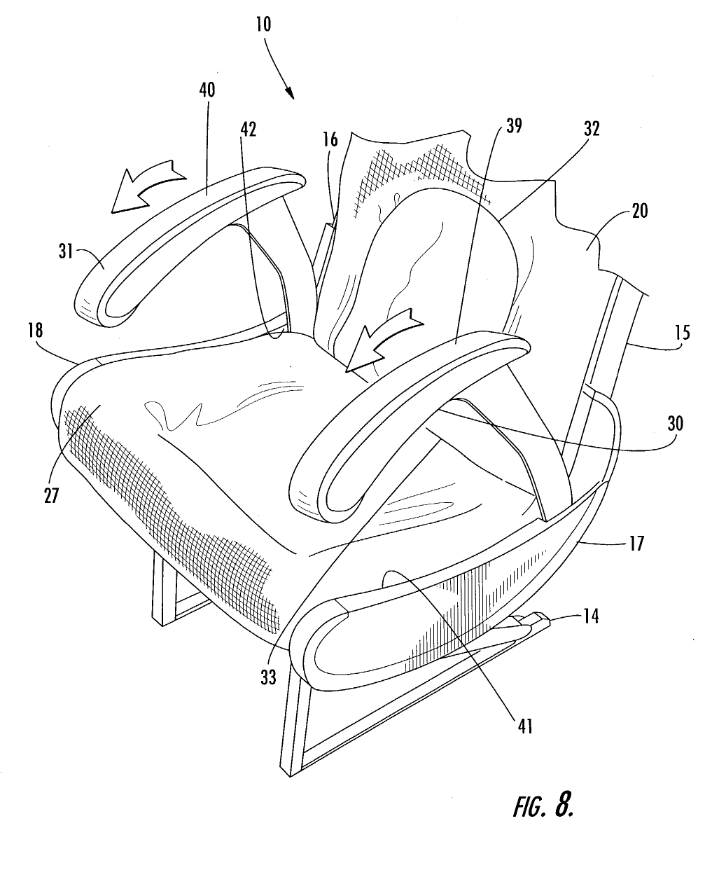

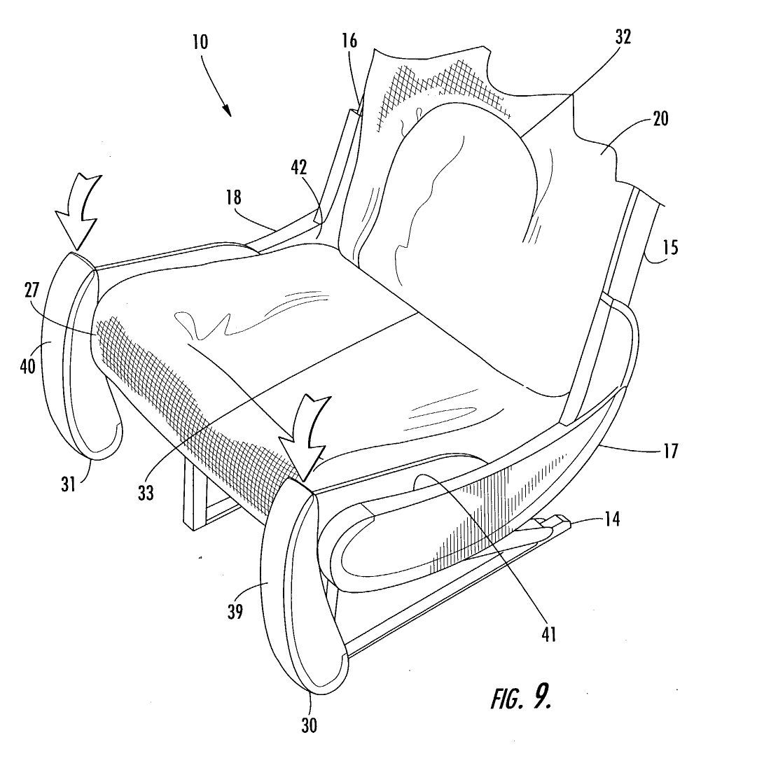

Referring now to FIG. 6, the armrests 30 and 31 may be moved from the locked use position by applying an upwardly-directed force to each armrest 30 and 31 in the direction “D₃” shown, which initiates movement of the armrests 30 and 31. Movement of armrest 30 is shown in FIG. 7. Application of the upwardly-directed force causes the male detent surface 43 to disengage from the female detent surface 44 so that the armrest 30 moves away from the lateral support 18. As is shown in FIG. 8, once they are disengaged, armrests 30 and 31 may be pivoted forward and downward. The armrests 30 and 31 continue to move forward and downward until they arrive at the stowed position shown in FIG. 9. When in the stowed position, armrests 30 and 31 are positioned so that their respective upper surfaces 39 and 40 extend generally perpendicular to the upper surface of the seat bottom pan 24 and below the forward edge 28.

Structuring the armrests 30 and 31 to pivot downward instead of upward overcomes several disadvantages exhibited by prior art armrests. Because the armrests 30 and 31 do not move upwardly, no extra space is needed between adjacent seats 10 to accommodate the armrests 30 and 31 when the armrests are placed in stowed positions. This permits the width of each seat 10 to increase without increasing the overall width of a group of seats 10 installed side-by-side on the deck of an aircraft. Furthermore, unlike the pivot mechanisms utilized in prior art seats, the pivoting detent mechanisms used to effectuate movement of the armrests 30 and 31 are not exposed. As is shown in FIG. 8, the armrests 30 and 31 are also mounted in offset relation to the seat back frame member 12, which allows the width of the frame member 12 to be increased.

While movement of armrests 30 and 31 is preferably initiated by applying a downwardly-directed force on the respective upper surfaces 39 and 40, movement of the armrests may alternatively be initiated by depressing a latch located on or adjacent the armrests. The latch may be incorporated in one or both of the armrests 30 and 31 used on the seats of the present invention.

Referring now to FIG. 10, the seat 10 is shown with the cushioned surface overlying the leading edge 28 removed to reveal the interior components of the bolster 27. As discussed above with respect to FIG. 2, the bolster 27 moves in concert with the seat bottom pan 24, the seat back pan 20 and headrest 21 to cause the leading edge 28 to move forward and downward as the seat 10 moves into the reclined position. Concerted movement of the bolster 27 ensures that the bolster 27 remains positioned behind the passenger's knees throughout the movement of the seat 10, which reduces the risk of circulatory injury to the passenger. As is shown in FIG. 10, the bolster 27 includes a rectangular support 46 with opposing major forward and aft sides 47 and 48, respectively. Side 48 is connected to a forward edge 50 of interior seat bottom pan mechanism 51. The bolster 27 articulates under control of a motor (not shown) relative to an elongate bar 52 during movement of the seat bottom pan 24 and seat back pan 20 between the upright position shown in FIGS. 10 and 1, and the reclined position shown in FIG. 2. The bar 52 extends between and interconnects the inner sidewalls 40 and 41 of respective lateral supports 17 and 18.

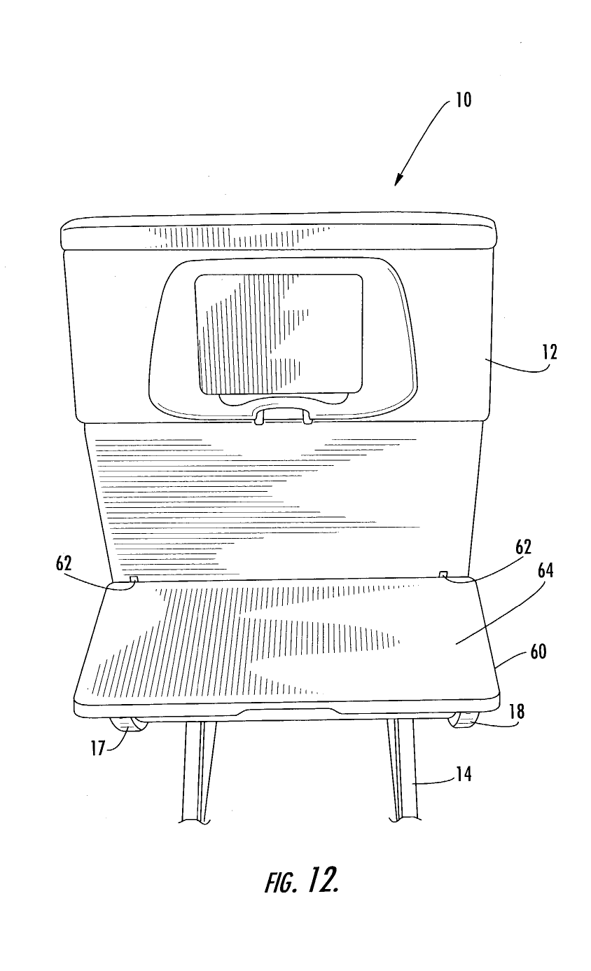

Referring now to FIG. 11, the aft-facing sides of the seat 10 and seat back frame member 12 is shown. A tray table 60 is connected to the seat back frame member 12 by a pair of pivots 62. Tray table 60 is shown in a stowed position flush against the aft-facing side of seat back frame member 12. The tray table 60 is held in place against the seat back frame member 12 by a latch 63. FIG. 12 shows the tray table 60 in an open use position in which the upper surface 64 of the tray table 60 is positioned generally perpendicular to the aft-facing side of the seat back frame member 12.

The tray table 60 may also include a double slide mechanism. Using the double slide mechanism, a passenger seated aft of the seat 10 may slide the tray table horizontally forward and aft to place the tray table in a cocktail position. Because the seat back frame member 12 is stationary, a passenger seated in seat 10 may move seat 10 without causing tray table 60 to move. Movement of any identical seat positioned adjacent to seat 10 will likewise not disturb the position of the tray table 60.

Although the tray table 60 does not require the use of independent table legs like se employed on conventional tray tables, alternative embodiments of the tray table of the present invention may include independent table legs.

A vehicle passenger seat is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A passenger seat, comprising:
(a) a seat base for being mounted on a support surface;
(b) a seat frame carried by the seat base, said seat frame including a seat bottom frame member and a seat back frame member positioned in a fixed angular relation to each other and the seat base;
(c) a seat bottom pan positioned on the seat bottom frame member;
(d) a seat back pan positioned on the seat back frame member; and
(e) guide means cooperating with the seat bottom pan and the seat bottom frame member and the seat back pan and seat back frame member, respectively, for unison translational movement of the seat back pan and the seat bottom pan between an upright position when the seat bottom pan is in an aft position and a recline position when the seat bottom pan is in a forward position, the angular relation between the seat back pan and the seat bottom pan causing axial rotation of a passenger seated in the seat between an upright and recline position within the seat frame without movement of the seat back frame.

2. A passenger seat according to claim 1, wherein said guide means comprises:
(a) a plurality of spaced-apart rollers carried collectively by said seat bottom pan and said seat back pan and projecting outwardly from opposing lateral sides thereof; and
(b) respective guide slots formed in the seat bottom frame member and the seat back frame member within which the rollers are positioned for movement therein.

3. A passenger seat according to claim 1, wherein said guide means comprises:
(a) a plurality of spaced-apart rollers carried collectively by said seat bottom pan and said seat back pan and projecting outwardly from opposing lateral sides thereof; and
(b) respective guide slots formed in the seat bottom frame member and the seat back frame member within which the rollers are captured for movement therein.

4. A passenger seat according to claim 1, wherein said guide means comprises a plurality of spaced-apart rollers and complementary guide slots carried by the seat bottom pan, seat back pan, and seat bottom frame member and seat back frame members, respectively.

5. A passenger seat according to claim 1, and including a tray table pivotally attached to an aft-facing side of the seat back frame member for movement between:
(a) a storage position against the seat back frame member; and
(b) a lowered use position, the fixed position of the seat back frame member permitting use of the tray table in the lowered use position without regard to whether the passenger in the seat is in the upright or recline position.

6. A passenger seat according to claim 1, and including at least one armrest pivotally mounted to a side of the seat bottom frame member and moveable between:
(a) a raised use position wherein an arm support surface of the armrest resides above the seat bottom pan for supporting the forearm of a passenger; and
(b) a lowered storage position.

7. A passenger seat according to claim 1, and including a pair of armrest assemblies pivotally mounted to opposing sides of the seat bottom frame member and moveable between:
(a) a raised use position wherein an arm support surface of at least one of said armrest assemblies resides above the seat bottom pan for supporting the forearm of a passenger; and
(b) a lowered storage position.

8. A passenger seat according to claim 6, and including locking means for locking the armrest in the raised use position and for unlocking the armrest for movement into the lowered storage position.

9. A passenger seat according to claim 8, wherein said locking means comprises a detent assembly including at least one complementary pair of semicircular male and female detent members movable between a locked position with the male detent member received in the female member and an unlocked position with the male detent member removed from the female member.

10. A passenger seat according to claim 6, wherein in the lowered storage position the armrest is perpendicular to the raised use position.

11. A passenger seat according to claim 6, wherein in the lowered storage position the arm support surface of the armrest resides forward of and at the level of the seat bottom pan.

12. A passenger seat according to claim 7, and including a leading edge bolster positioned on a leading edge of the seat bottom pan and movable between a raised position when the seat is in the upright position and a lowered position when the seat is in the reclined position for relieving pressure on the lower thigh of the passenger.

13. A passenger seat according to claim 12, wherein the bolster is positioned for sliding movement on a laterally extending bar mounted below the seat bottom pan.

14. A passenger seat according to claim 12, wherein the bolster is biased towards the lowered storage position.

15. A passenger seat, comprising:
(a) a seat base for being mounted on a support surface;
(b) a seat frame carried by the seat base, said seat frame including a seat bottom frame member and a seat back frame member positioned in a fixed angular relation to each other and the seat base;
(c) a seat bottom pan positioned on the seat bottom frame member;
(d) a seat back pan positioned on the seat back frame member; and
(e) guide means cooperating with the seat bottom pan and the seat bottom frame member and the seat back pan and seat back frame member, respectively, for translational movement of the seat bottom pan and the seat back pan between an aft position and a forward position.

16. A passenger seat according to claim 15, and including at least one armrest pivotally mounted to a side of the seat bottom frame member and moveable between:
(a) a raised use position wherein an arm support service of the armrest resides above the seat bottom pan for supporting the forearm of a passenger; and
(b) a lowered storage position.

17. A passenger seat according to claim 15, and including a leading edge bolster positioned on a leading edge of the seat bottom pan and movable between a raised position when the seat is in an upright position and a lowered position when the seat is in a reclined position for relieving pressure on the lower thigh of the passenger.

18. A passenger seat according to claim 15, and including guide means cooperating with the seat bottom pan and the seat bottom frame member and the seat back pan and seat back frame member, respectively, for translational movement of the seat bottom pan between an aft position and a forward position, and for unison translational movement of the seat back pan and the seat bottom pan between an upright position when the seat bottom pan is in an aft position and a lowered position when the seat bottom pan is in the forward position, the fixed angular relation between the seat back pan and the seat bottom pan during the translation unison movement causing axial rotation of a passenger seated in the seat between an upright and reclined position within the seat frame and without aft movement of the seat back frame during recline movement.

19. A passenger seat according to claim 18, and including a tray table pivotally attached to an aft-facing side of the seat back frame member for movement between:
(a) a storage position against the seat back frame member; and
(b) a lowered use position, the fixed position of the seat back frame member permitting use of the tray table in the lowered use position without regard to whether the passenger in the seat is in the upright or reclined position.
